(19) United States
(12) Patent Application Publication
(10) Pub. No.: US 2025/0158804 A1
(43) Pub. Date: May 15, 2025

(54) Method for randomized data hybridized handshake wrapped around AES, or similar symmetric encryption allowing mutual secure exchange and generation of symmetric session keys, wherein sender, receiver and any command instructions are mutually and simultaneously authenticated, while only sending 100% randomized data, with the exception of a hashed or encrypted user ID

(71) Applicant: Chad Edward Wanless, Saskatoon (CA)

(72) Inventor: Chad Edward Wanless, Saskatoon (CA)

(21) Appl. No.: 18/105,862

(22) Filed: Feb. 5, 2023

(51) Int. Cl. H04L 9/06; H04L 9/32

(52) U.S. Cl. CPC H04L 9/0643; H04L 9/0631; H04L 9/3271

(57) ABSTRACT

The Randomized Data Handshake (RDH) encryption system method is presented herein. Embodiment herein provides methods and means to provide secure encryption tools designed for AES encryption or similar symmetric encryption, with the goal of reducing or removing existing vulnerabilities which includes technologies such radio and induction transmitting, and quantum computer resiliency. The embodiment herein differs from all other encryption hybridized handshake methods in that typical handshakes encrypt the username and password and transmit both for authorization after receiving a public key. This software invention differs in that two pre-exchanged authentication keys allow mutual authentication using only randomly generated challenge codes and modified check sum data packets, allowing mutual authentication of sender, receiver, command instructions, database query commands and/or hexadecimal form plain text are transmitted via 100% randomized data, without directly transmitting passwords, passcodes or other authentication data, with exception of an encrypted user ID for account and key lookup.

### BACKGROUND

### Technical Field

The embodiment herein relates to cryptograph, a handshake in which non-pubic keys and check sum test data packet(s) are exchanged for multi-key encryption of data and command, database query and plain text hexadecimal transmittals.

### Description of Related Art

The invention herein was created to combat a specific electronic theft and fraud threat recognized worldwide as online data breaches and various low-cost tech attacks. One only needs to look at the news to hear periodically of large corporations being hacked and personal data being compromised and stolen. Only the largest of breaches are mentioned in the news where hundreds of thousands or millions of customers' data is stolen during a single event. The number of smaller commercial entities data breaches could total just as many if not more customer personal data, but seldom mentioned in the news.

Other more well-known encryption asymmetric algorithms like the RSA method use complex math formulas to minimize key sizes. The RSA method has recently been demonstrated to be vulnerable to reverse engineering of 256-bit sizes in under one minute. In addition, with the recent invention of quantum computers, math processes that would take silicon-based computers, millions of years to calculate, will only take seconds more minutes for a quantum computer. Quantum computes can mathematically compute all possible key combinations at the same time on math-based algorithms, rending traditional encryption methods vulnerable. With the new threat of quantum computer decryption, standard asymmetric encryption programs are being rendered obsolete and will be unable to protect data using current encryption. AES symmetric is currently considered quantum safe. However, AES is unable to create and transmit its own session keys and therefore relies upon asymmetric encryption to create and transmits the session keys. The invention herein is a specialized handshake that allows AES and other symmetric key algorithms to create and transmit their own session keys. It is this inventor's view that all asymmetric encryption systems, which are based on math formulas, are potentially vulnerable to quantum computer attacks.

The invention herein requires both parties to have previously exchanged two part-one and part-two authorization keys or complex data that can be converted to the two authorization keys. The handshake is designed to allow an authorization, command code, database query or hexadecimal values to be exchanged via only 100% randomized date without directly sending the authentication data.

Pre-exchanging keys is not a problem with IoT, IIOT and Fintech devices as they come preloaded with the authorization keys. This invention should not be considered in competition with the post quantum selected algorithms, but instead seen as complimentary to. The selected post-quantum algorithms are data heavy and time consuming to process. The invention herein processes much faster and results in much small transmittal packets. When required, a post quantum algorithm should be used for account sign up and registration, then this invention used thereafter for faster, smaller account logins.

Where the two-part authorization keys have been previously exchanged and registered, the invention herein uses data known by both the user or sender and receiver, which consists of a commonly known passcode as a two-part authentication key.

Wherein a user enters a simple password, the password is not sufficiently complex and therefore must be combined with other registered unique data from the user's computer or device, such as serial numbers to create the authentication key via SHA-256 hashing or similar algorithm.

The process starts by creating randomly generated numbers, called the challenge code is encrypted using the part-one authentication keys, which is then transmitted by either the sender receiver. The both sender and receiver create their own copied of the session keys using one of four possible methods. Another set of randomly generated numbers act a counter challenge code and are called the check sum test data, which is encrypted using the session keys and transmitted back to the sender. The sender decrypts the check sum test data using the copy of the part-one authorization keys. The checksum test data is re-encrypted by either session keys it generated, or a command code key, database query key or hexadecimal key and transmitted back to the receiver. The receiver decrypts the check sum test data, then the session keys, command keys, database query or hexadecimal key, the decryption key which matches sent check sum test data, defines if the sender entered their authentication keys correctly, and/or which command instruction, database query or hexadecimal value(s) was transmitted. Since both parts of the authentication keys are never transmitted, decrypting them becomes extremely difficult.

The session keys are generated by one of four methods; (1) the 256-bit challenge key is copied directly into the session keys, (2) session keys are randomly generated and encrypted by the challenge key, (3) the challenge key encrypts the 256-bit part-two authentication keys to become the session keys, or (4) which is the preferred method, wherein the 256-bit challenge key contains address lookup values which are in turn are used to extract a 256-bit subset of keys from the 2,048-bit part-two authentication keys thereby creating 256-bit session keys. Options (3) and (4) result with session keys that are never directly transmitted. Option (4) has further advantages in that each login intentionally only uses a portion of the part-two keys. Attacking a single intercepted handshake with any attack method will never provide the full part-two keys as only ⅛^{th} of the keys was used during the encryption process. This has tremendous advantages for applications where only a limited number of transmittals is available for interception.

The prime example for this is Fintech bank card and credit card purchasing and e-commerce applications. Purchases can be made without transmitting the authorization keys or bank or credit card numbers. Only the banking institution ID and the user identification (recommended to be a database lookup index value for reduced database lookup and search time) are directly transmitted as encrypted data contained within the UID. In places of business using Point of Sale (POS) terminals, customers typically only make one purchase, sometimes two if something was forgotten. Limiting “Tap” purchases to four or five between requiring the customer to enter a PIN will limit portable card readers used to download data which is encrypted ½ or five eights of the 2,048-bit part-two authorization keys. The new Fintech cards must be designed to process the encryption on behalf of the POS terminal and not provide any means by which to download the authentication keys directly. The memory must be “write only” with a limited use function method to test if the upload keys function properly.

Online E-commerce applications can use the credit card purchasing system as a trusted third party to simultaneously authenticate the new user and generate session keys for which the new user can use to transmit their account setup data, customer preferences and purchasing decisions. Additionally, where credit card data is stored on e-commerce servers, the check sum test data is separately encrypted by the corporation's account keys and the customer's authentication keys.

The customer's UID is also encrypted. When processed the bulk purchasing server decrypts the corporate check sum test data, looks up and uses the customer's authentication keys to decrypt the check sum test data. These combined keys can only be authorized through a bulk submittal system not open to the public for processing. This ensures that if the data is stollen in a data breach, the hacker(s) will only be able to give money to the corporation with no means to determine the full part-two authorization keys as only ⅛^{th} of the keys were used during encryption. Additionally, there are no means by which to receive physical goods or services as the bulk transmittal system does not include product selection during authorization. The corporate keys used to encrypt the credit card for latter bulk submittals are never stored on the corporate servers, only stored by the purchasing server, ensuring that in the case of a corporate data breach, the keys will not be found.

### Definitions, Acronyms and Abbreviations

Through this specification, the following definitions are employed:

Array: An Array is a data structure, which can store a fixed size collection of same type data. An Array is used to store a collection of data. An analogous example, post office boxes or spreadsheet. In either, there are a number of rows and columns. A simply array would represent the top most row only. A nested array would be the entire set of post office boxes. In in programming and short form in this document Arrays are displayed as a name followed by a value or variable in brackets, for example, when creating an array A [256] indicates an array named ‘A’ that holds 256 different values, when setting or retrieving data, A [10] means it is looking at the 10th address, called the index, for the data. It is important to note, the value range for arrays always start at 0 and ends at the length minus one.

AES: Stands for Advanced Encryption Standard originally named Rijndael developed by two Belgian cryptographers, Joan Daemen and Vincent Rijmen.

Asymmetric Key: Asymmetric keys uses public and private keys to encrypt and decrypt data. The numbers are two different sets of numbers that are mathematically related. The public key is used to encrypt data and the private key is used to decrypt the data.

ASCII: (American Standard Code for Information Interchange) is the most common format for text files in computers. In ASCII each alphabetic, numeric, or special character is represented with a 7-bit binary number, representing 128 English characters as numbers from 0 to 127. For example, the number 65 represents the letter “A”.

Bit: A bit is the smallest unit of computer data consisting of either a 0 or a 1.

Brute Force Attack: A brute force attack is where computer is written to systematically test an encrypt key by repeatedly submitting a new key with each test and incrementing by a value of 1 until plain text can be read. For example, with a remote car unlock, a brute force attack would start at 000000 and increment by a value of 1 up through 999999 or until the car doors unlock.

Byte: A byte is unit of storage capable of holding a very small number or text character and is equal to 8 bits. A byte can store a value between 0 and 255.

Character: A unit of information that stores a symbol such as an alphabet, numeric or syllabary in the written form of a nature language. A Character can consist of 1 or 2 bytes represented with ASCII or Unicode characters.

Commercial Corporation: A company that operates an online service.

Concatenate: Is the process of appending one text string to the end of another text string. Where numbers are to be concatenated, the numbers are first to be converted to a text string.

Data Packet: A Data Packet is a unit of data made into a single package that travels along a given network path. Data Packets are used in Internet Protocol (IP) transmissions for data that navigates the web and in other kinds of networks.

Encryption Key: In cryptography, a key is a variable value that is applied using an algorithm to a string or block of unencrypted text to produce encrypted text or to decrypt encrypted text.

For Loop: In programming a For Loop is a control flow function use for specifying iteration, which allows code to be execute repeatedly. For Loops are used to when a numeric range is known before entering the loop. For example, when adding an array of values, the loop would start at 0, the lowest index value of the array and iterate for the length of the array.

Function: A term used to define a software command that performs a computation action.

Hexadecimal: Hexadecimal describes a base 16 number system rather than the 10 as its base. The values range from 0 through 9 followed by ‘A’ through ‘F’, ‘F’ being equal to the number 15. Characters are shown normally as values of 0 through 256. In hexadecimal, the values are shown as 00 through FF.

Index: An index is a placement or location number in arrays and lookup matrix tables. For example, if the index value is 5, then the array will return the value located in array location for that number.

Integer: With computer programming languages, an integer is a variable that store a whole number without fractions or decimals. Integers use 32 bits, or 4 bytes of computer memory and can store values that range from −2,147,483,648 to 2,147,483,647.

Method: A Method allows a computer program to preform an action, computation and/or return a value.

Nested Array: A Nested Array is an array that stores arrays inside of the array. See Array.

Object: In the class-based object-oriented programming languages, the term object refers to a particular instance of a class, where the object can be combination of variables, functions and data structures. For example, in the windows-based computer system, each user interface, such as a button is an object class called a Button.

Randomly Generated Number: a mathematical construct, either computational or as a hardware device, that is designed to generate a random set of numbers.

Short: A short is unit of numeric storage capable of holding a whole number and is equal to 16 bits. A short can store a value between −32,768 and 32,767.

Symmetric Key: Symmetric key system is an encryption system which is simpler and faster than asymmetric keys, wherein both parties must exchange the keys in a secure way before data transmission of data can commence.

Unicode: An international encoding standard for use with different languages and scripts, by which each letter, digit or symbol is assigned a unique numeric value that applies across different platforms and programs. Unicode characters consists strictly of 2 bytes.

Variable: In Computer programming, a variable is a storage location identified by a memory address, paired with an associated symbolic name which contains information important to the program.

### SUMMARY

In view of the foregoing, the invention herein has been designed to provide an extremely secure method of data encryption for personal or corporate data, in transit or at rest. Furthermore, the invention herein is designed to allow for secure online internet data authorization logins and command instruction transmittal using a hybridized handshake which transmits two sets of pre-exchanged symmetric keys and 100% randomized test data between users and online servers, or sender and receiver without actually directly sending the session keys, authorization keys, command keys, database query keys or hexadecimal value keys. The invention herein in referred to Randomized Data Handshake (RDH).

The current industry standard symmetric algorithm Advanced Encryption Standard (AES) is considered quantum resilient, however, is unable to create and exchange its own session keys and therefore currently relies upon asymmetric algorithms such as RSA to exchange the session keys on its behalf. The invention herein (RDH) is a wrap around standard designed to allow AES to allow AES to create and exchange its own session keys when both parties have pre-exchange authentication keys.

### The Problem(s)

With today's encryption, there are several modes and means by which to decrypt and work arounds which allow bad actors to either decrypt encrypted data or use one of many possible work-around software programs or hardware designed to defeat current security hardware and software. The invention herein has been designed to counter specific modes of software and hardware attacks for several niche markets.

These markets include, but are not limited to, automotive key fobs (the original design intent), autonomous automotive vehicle controls (including drones), debit and credit card intelligent smart cards, POS terminals, online credit card purchasing, office access swipe smart cards, office and government second factor authorization (2FA) using office swipe smart cards and a specialized “Tap” reader, intelligent RDH enabled key boards that allow 2FA access only to data and files stored on secure servers. While RDH is designer specifically for hardware devices with pre-loaded authentication keys, RDH can be used for software only security solutions. A password manager is required to convert users' simple passwords into complex two-part authentication keys using one-way hashes such as SHA-256.

For software base requirements, RDH is not designed to compete against the asymmetric post quantum candidate algorithms, but instead complement them as RDH being a wrap around for AES encryption operates faster than asymmetric encryption. An asymmetric algorithm would best suited for first time account setups and RDH and the password manager for all subsequent logins.

Quantum computers are hardly the only threat the hardware and software. RDH was designed originally specifically to combat existing low cost work-around hardware based attacks against car fobs and smart banking cards. Car fobs are currently vulnerable to brute force attacks, relay attacks and a type of man-in-the-middle attack called a rolljam attack. Bank debit and credit cards are currently vulnerable to walk by swipe readers, under counter card readers, bank machine adapted readers, POS terminal swaps and keyboard stroke recording malware. RDH counters these vulnerabilities by exchanging only 100% randomized data, with the exception of an encrypted or hashed User ID (for receiving device authentication lookup) and by having the hardware device process the encryption directly (on behalf of POS terminals). RDH also intentionally only uses 256-bits of the 2,048-bit part-two authentication keys, which forces multiple required interceptions just to be able to get enough data to begin processing for the keys. This last feature means that, where limited numbers of intercepts are possible (such as instore purchases), there is no means literally no means by which to determine what the full part-two authentication codes are.

### BRIEF DESCRIPTION OF THE DRAWINGS

Randomized Data Handshake overall flow diagrams:

FIG. 1 illustrates the standard randomized data handshake transmittal flow chart

FIG. 2 illustrates the RFID tap enabled randomized data handshake transmittal flow chart

FIG. 3 illustrates the Hexadecimal transmittal randomized data handshake flow chart

FIG. 4 illustrates the standard POS terminal and E-Commerce transaction flow chart

FIG. 5 illustrates the trusted third-party new account verification and setup flow chart

FIG. 6 illustrates the credit card and corporate data encryption for safe third-party database storage flow chart

FIG. 7 illustrates the bulk credit card transaction flow chart

FIG. 8 illustrates the internet of things (IoT) or similar, new device registration flow chart

### DETAILED DESCRIPTION OF PREFERRED EMBODIMENTS

The embodiment herein and the various features and advantageous detail thereof are explained more fully with reference to the non-limiting embodiments that are illustrated in the accompanying drawings and detailed in the following description. The examples used herein are intended merely to facilitate an understanding of ways in which the embodiments herein may be practiced and to further enable those of skilled in the embodiments herein. Accordingly, the examples should not be construed as limiting the scope of the embodiments herein.

The embodiments herein provide methods to generate keys, encrypt, decrypt, authorize and remotely instruct devices via transmitted data via the internet, radio transmissions and other transmission means.

Before describing the illustrated figure drawings, it is important to describe the invention (RDH) methodology. RDH creates the challenge code and check sum test data packets which are encrypted by the receiving party using the part-one authorization keys and a session key (or one of many possible command code keys, database query keys or hexadecimal value keys) is generated from the part-two authorization keys using the challenge code as lookup addresses. Multiple check sum test data packets are modified to represent each possible command or hexadecimal character found within the plain text to be transmitted. The receiving device decrypts each received check sum test packet against all the command or hexadecimal keys. The deciphered values that match the sent values indicates which command or hexadecimal values were indicated by the sender. This type of handshake encryption makes it virtually impossible to decipher the intended commands or the plain text values. Where a session key is not required, for example simple remote-controlled devices, the optional challenge code need not be generated. However, multiple part-two authentication keys are instead required, one for each command.

Regarding the hybridized encryption handshake, this invention further provides methods and means for secure data transmissions intended to be immune to quantum computer decryption hacking. As previously described, online data transmissions would be setup using a challenge and counter challenge code handshake method, wherein a user's device would use pre-share two-part private keys, called the authentication keys, which may be preloaded onto sending and receiving devices, for example remote keyless systems (car fobs), or in other uses are required to be generated from data known to both the sender and the receivers. The authentication keys could be generated from, for in the example of online credit card purchase, the credit card numbers, security numbers, expiration data, address, phone number and email address of the purchaser. In the example of a smart phone device or personal computer, the username, password and the device's unique information such as various serial numbers, installed hardware identifications and types all which would be combined to create the authorization keys and would be unique to that user's device.

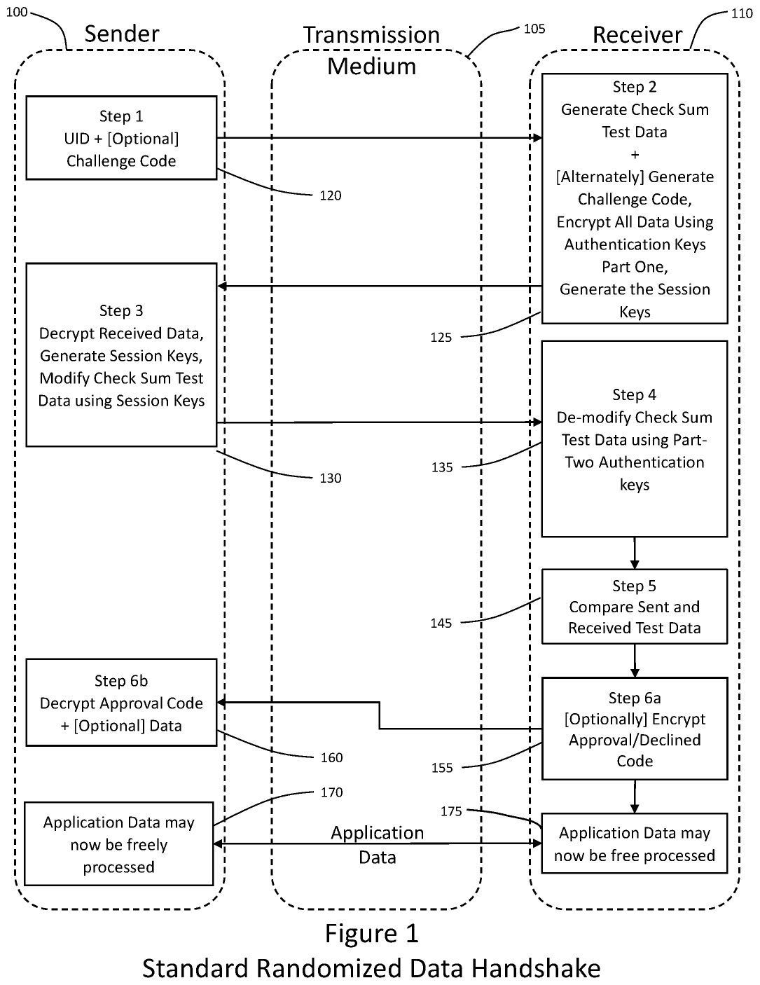

FIG. 1 illustrates a randomized data handshake for login authorization transmittal flow chart. The handshake begins with the sending device 100 transmitting a signal, 105 to the receiving device, 110. The handshake begins with Step 1, (claim 9) encrypting a user identification value and optionally the challenge code, 120. Step 2, (claim 10) the receiving device creates the check sum test data packet(s), if not created in step 1, generates the challenge code and encrypts all using the part-one authentication keys, generates the session keys, then sends the data back to the sender, 125. Step 3, (claim 11) the sending device now decrypts the received data, generates the session keys, command code keys, database query keys or hexadecimal value keys, modifies the check sum test data packet(s) using the keys generated, then sends the data back to the receiver, 130. Step 4 (claim 12) the receiving device then decrypts the check sum test data packet(s) using one of the generated keys, 135. Step 5 (claim 13) the sent and received check sum test data packet(s) are compared, 145, the key that correctly decrypts the test data packet indicates that the sender used the correct authentication keys without directly sending the authentication data. Step 6a (claim 17) optionally encrypt an approval or declined message and transmit back to the sender, 155. Step 6b (claim 17) decrypt the approval code to confirm mutual authentication, 160. Any application to be transmitted may be freely encrypted using the session keys or hexadecimal value keys either the sending device, 170, or the receiving device, 175.

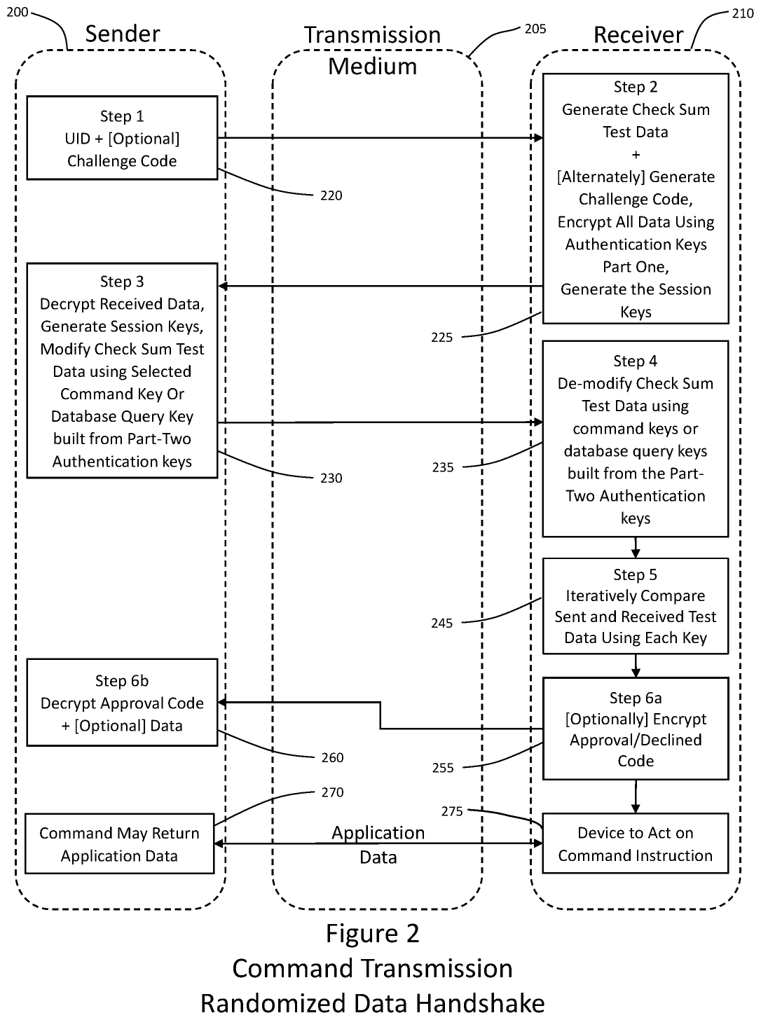

FIG. 2 illustrates a randomized data handshake for command instruction, database query or hexadecimal value transmittal flow chart. The handshake begins with the sending device 200 transmitting a signal, 205 to the receiving device, 210. The handshake begins with Step 2, (claim 9) encrypting a user identification value and optionally the challenge code, 220. Step 2, (claim 20) the receiving device creates the check sum test data packet(s), if not created in step 2, generates the challenge code and encrypts all using the part-one authentication keys, generates the session keys, then sends the data back to the sender, 225. Step 3, (claim 21) the sending device now decrypts the received data, generates the session keys, command code keys, database query keys or hexadecimal value keys, modifies the check sum test data packet(s) using the keys generated, then sends the data back to the receiver, 230. Step 4 (claim 22) the receiving device then decrypts the check sum test data packet(s) using one of the generated keys, 235. Step 5 (claim 23) the sent and received check sum test data packet(s) are compared, 245, the key that correctly decrypts each test data packet indicates that the sender used the correct authentication keys and simultaneously indicates which command, database query, or hexadecimal value was being indicated by the sender without directly sending the data. Step 6a (claim 27) optionally encrypt an approval or declined message and transmit back to the sender, 255. Step 6b (claim 27) decrypt the approval code to confirm mutual authentication, 260. Any application to be transmitted may be freely encrypted using the session keys or hexadecimal value keys either the sending device, 270, or the receiving device, 275.

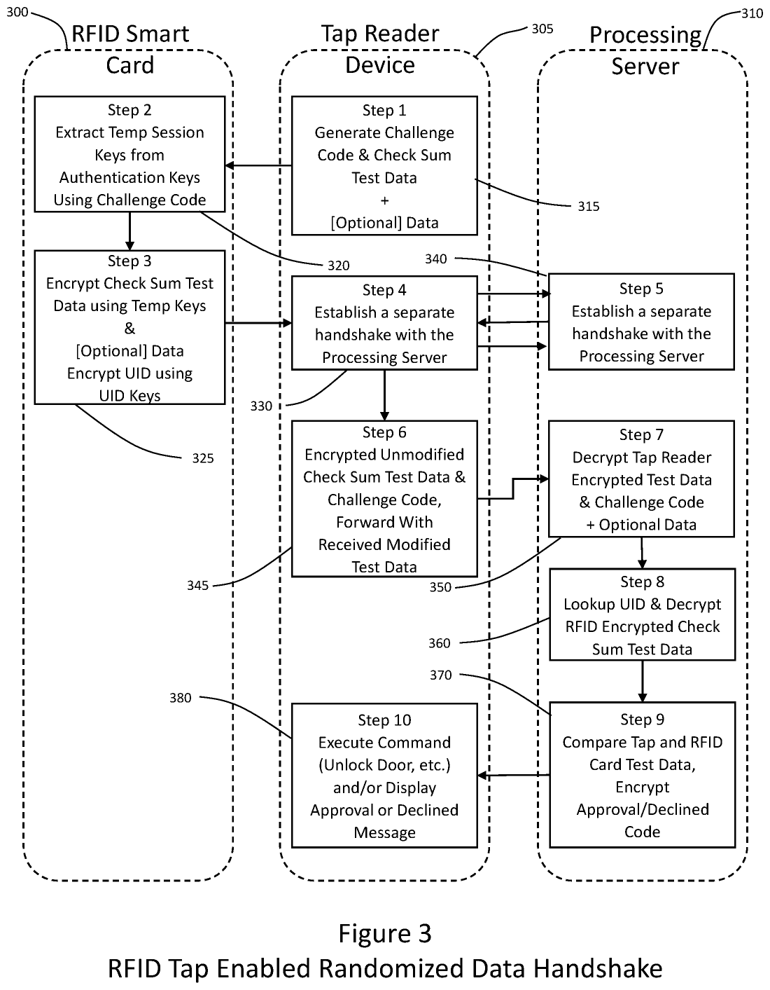

FIG. 3 illustrates a randomized data RFID Tap authorization. The handshake begins with the RFID smart card 300 interacting directly with an RFID tap reader, 305, which sends data to the receiving processing server, 310. Step 2 begins with the tap reader generating a challenge code and a check sum test data packet and optional data such as purchase price, 315. The data is transmitted to the RFID smart card for processing via induction. Step 2, the RFID smart card extracts temporary 256-bit session key from the 2,048-bit part-two authentication keys using the received challenge code, 320. Step 3, encrypt the check sum test data using the session keys and encrypt any received data, the encrypt the UID and transmit the data back to the tap reader, 325. Step 4 & 5, establish a separate handshake with the processing server, 330 and 340. Step 6, encrypt the challenge code and unmodified check sum test data, forward along with the received check sum test data to the processing server, 345. Step 7, decrypt the tap reader's encrypted challenge code and check sum test data and any received optional data (such as purchase price), 350. Step 8, lookup the UID and decrypt the RFID encrypted check sum test data, 360. Step 9, compare the decrypted tap and RFID card check sum test data values, if matches encrypt an approval code, if not, encrypt a declined code and transmit back to the Tap reader, 370. Step 20, execute command (unlock door, etc.) and or display approval or declined message, 380.

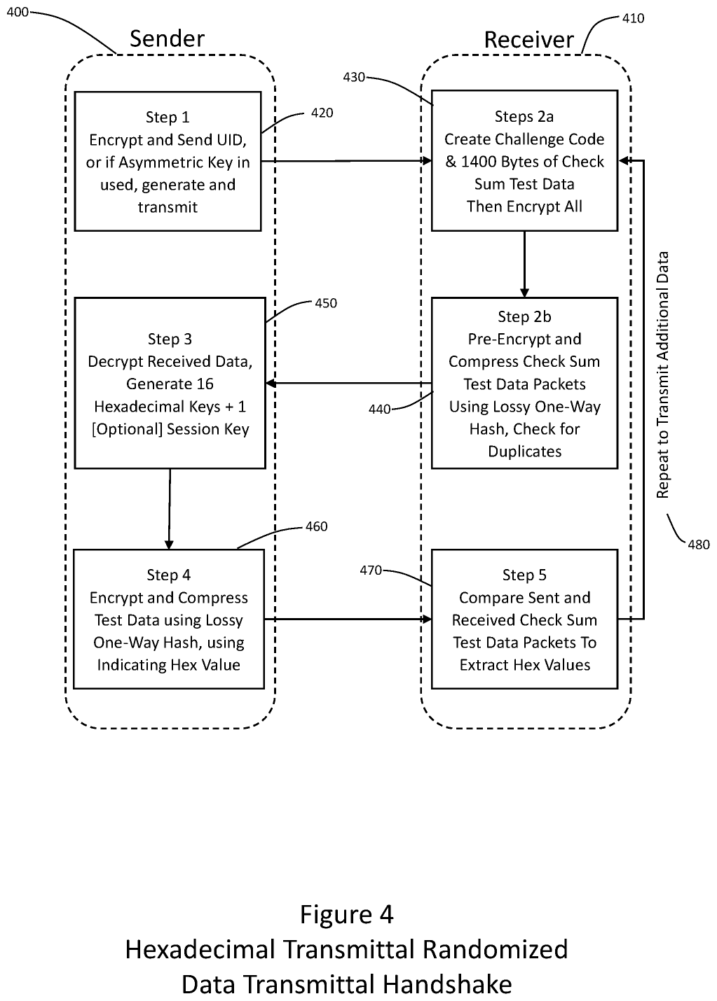

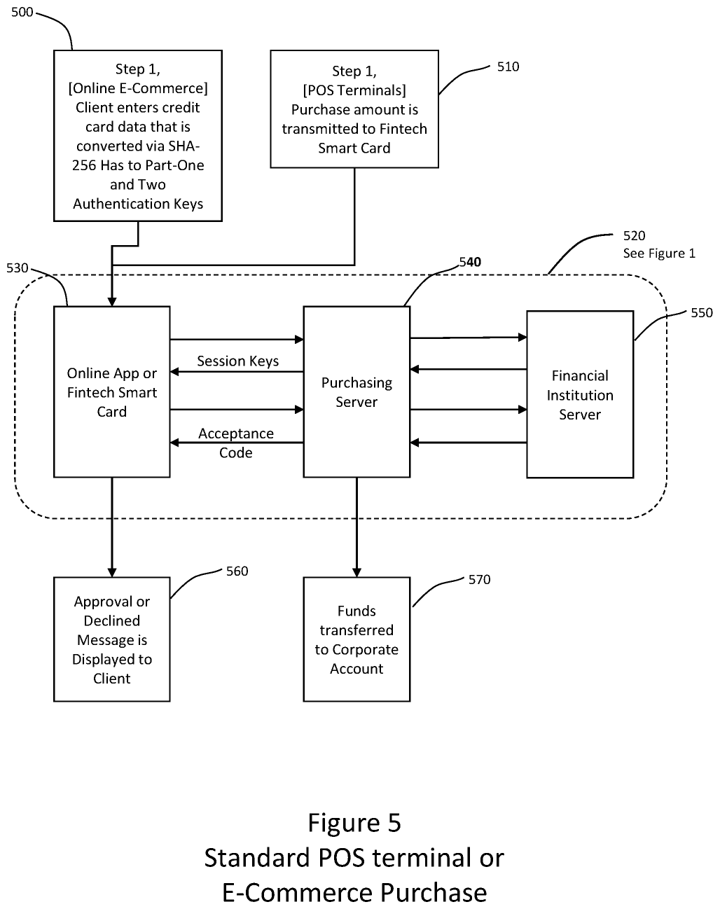

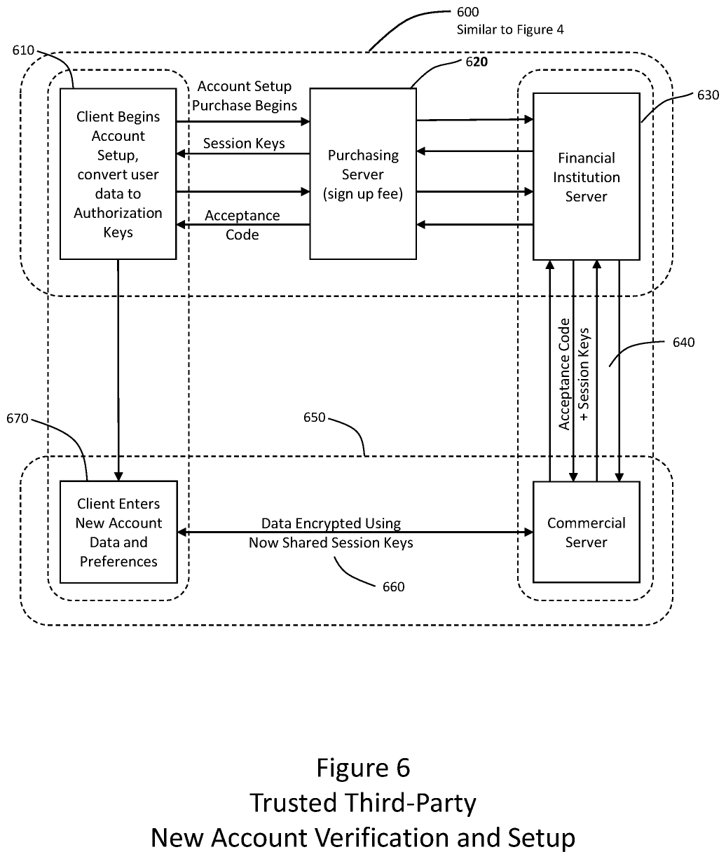

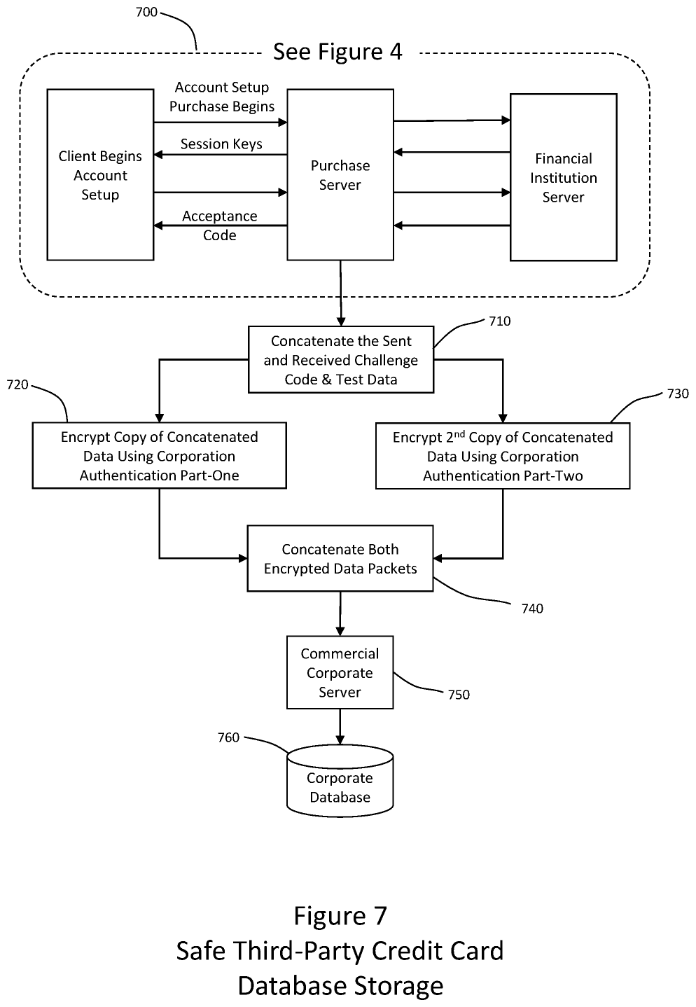

FIG. 4 illustrates a randomized data hexadecimal handshake transmittal between a sending device, 400 and the receiving device 410. This handshake can use both symmetric and asymmetric keys to securely transmit hexadecimal values. Step 2, encrypt and send UID, or create asymmetric key and transmit to the receiving device, 420. Step 2a, create 26 or 27 challenge codes, (the 27th to confirm authorization), create and encrypt 2400 bytes of check sum test data, 430. Step 2b, pre-encrypt and compress the check sum test data packets using a lossy one-way hashing algorithm, 440. Step 3, decrypt the received data, generate 26 hexadecimal keys and 2 additional session keys for authentication, 450. Encrypt each check sum test data packet using the hexadecimal value key to and compress using the lossy one-way hashing algorithm, optionally encrypt one test data packet for login authorization, 460. Step 5, compare each sent and received check sum test data packet to determine which hexadecimal values are to be used to build the plain text data, 470. Repeat to transmit additional hexadecimal data, 480.

FIG. 5 illustrates POS Terminal or online E-Commerce purchasing. Step 2, the online E-commerce app converts the manually entered credit card data to part-one and two authentication keys using SHA-256 hashing algorithm or similar, 500. Alternately, for the POS terminal purchases, the purchase amount is transmitted to the Fintech Smart Card, 510, which processes the purchase handshake on behalf of the POS terminal. The handshake is processed identically as described in FIG. 3, 520. Wherein the online app, or Fintech smart card processes the sent and received data, 530. The purchasing server, 540, acts mainly as a data courier and sends the data to the correct financial institution, 550. Upon handshake completion, the approved or declined message is displayed to the client, 560. The funds are then transferred to the corporate account, 570.

FIG. 6 illustrates the trusted third-party new account verification and setup flow chart, wherein a new account signup is processed similar to a standard purchase, 600, which is processed similarly to FIG. 5. The client begins by entering purchasing data, which is then converted to the part-one and two authorization keys, 610. A standard handshake is then processed with a purchasing server, 620, which in turn transmits the data to the appropriate financial server, 630. If approved, an additional handshake, 640, is established to transmit the session keys to the commercial server, 650. The client and commercial server are now able to securely communicate with a shared session key, 660. The client can now enter and setup their new account data and preferences, 670.

FIG. 7 illustrates the credit card and corporate data encryption for safe third-party database storage flow chart, wherein a credit card purchase transaction occurs as described in FIG. 5, 700. Upon completion and approval of the purchase, the purchasing server (being one of the credit card financial corporations) concatenates the encrypted data sent and received between the client and financial institution, 710. Then using the commercial corporation's account authentication keys part-one, re-encrypts the full copy of the data, 720. Then using the commercial corporation's account authentication keys part-two, separately re-encrypts the full copy of the concatenated data, 730. The two encrypted data packets are then concatenated together, 740. The final data is then transmitted to the commercial corporation's server, 750, which is then stored on their corporate server 760.

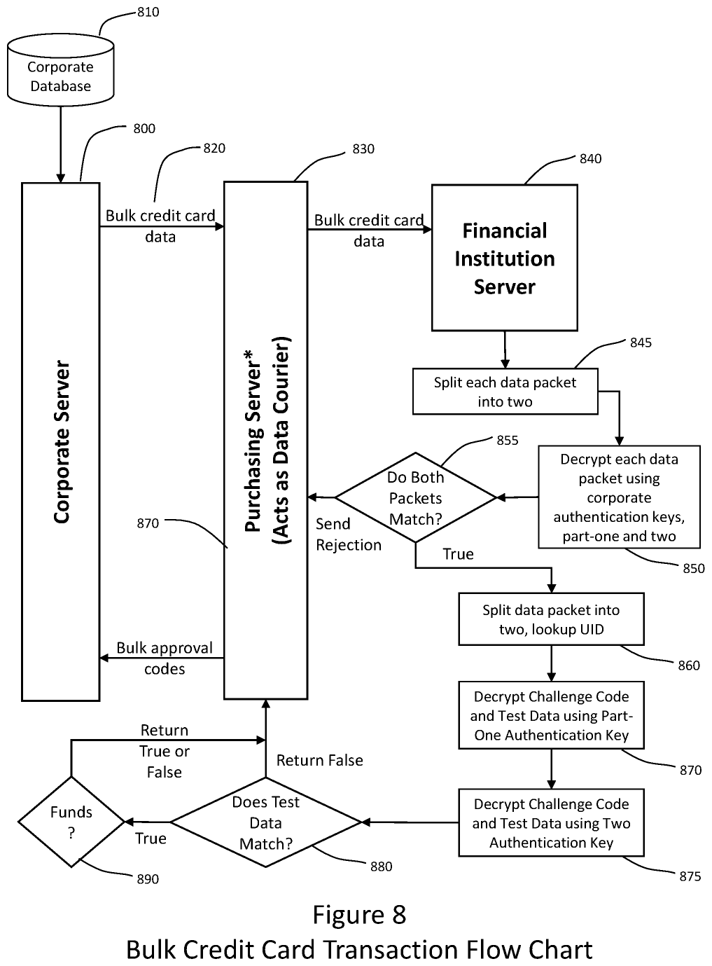

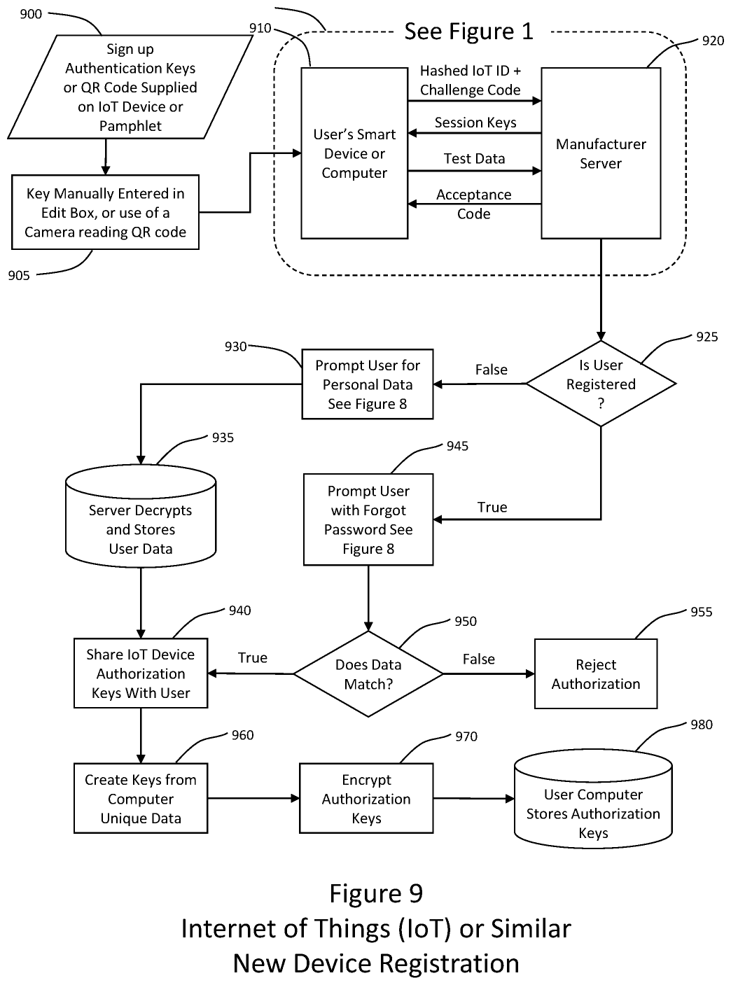

FIG. 8 illustrates the bulk credit card transaction flow chart, used for multi-customer monthly account renewal or repeat purchases. The corporate server, 800, begins with retrieving customers' account encrypted credit card data, previously encrypted by FIG. 5, 810. The data is packaged together and transmitted in bulk, 820, using a specialized bulk credit card purchase service, 830. The purchase server compares the hashed first four credit card digit for each customer and transmits the customer's data packet to the identified financial institution, 840, for approval. Each authorization here treated separately for processing, starting with splitting each data packet into two equal packets, 845. Each is then decrypted using the corporation's authentication keys part-one and part-two, 850. Test to ensure both packets match, 855, if not, return rejection code. If true, split the data packet into the standard purchase transactions of the User ID (UID), challenge code and test data, for data packet one and the modified test data packet copy, and lookup the UID to retrieve the client's authentication keys 860. Decrypt the first packet, (the challenge code and test data) using the authentication keys part-one, 870. Create the temporary session keys using the challenge code and part-two authentication keys, then decrypt the second data packet (modified test data), 875. Test to ensure both test data packets match, 880, if not return false. Lookup available funds, 890, return true or false.

FIG. 9 illustrates the internet of things (IoT) new device registration flow chart, wherein a manufacturer requires all customers to register new customer account before device authentication keys are supplied, the account signup keys will be supplied in the form of a printed pamphlet, 900, accompanying the device with either the keys printed as text to be typed in to an account signup page, or QR code for smart devices with a camera, 905. Note, if the IoT's direct access authorization keys are printed on the side of the device, the account sign-up becomes optional. The user's smart device or computer, 910, exchanges a handshake, see FIG. 3, 915, with manufacturer's server, 920. Once the manufacturer's server confirms the login authorization it checks to see if this device has been previously registered, 925, if false, the user is prompted for personal account registration data, 930. The encrypted data is decrypted and stored within the manufacturer's main customer database, 935. Share the IoT device's authorization keys with the user device, 940. If the IoT device was previously registered, this indicates the user is most likely registering an additional device or computer. To ensure an unauthorized user is unable to gain access, the user is prompted with the forgot password prompt, 945. The display to the user may be titled differently, however, using the forgot password function, see FIG. 8, allows the server to authenticate the user entering the data from an additional computing device, if the data does not match, send authorization declined signal, 955. If the data does match, share the IoT device's authorization keys with the user device, 940. Once shared, the user's computer or smart device creates encryption keys using unique data, such as serial numbers from the device, 960, which as then used to encrypt the IoT device authorization keys, 970, then stored on the user's device for later retrieval, 980.

The invention claimed is:

1. A hybridized encryption handshake method which is designed to be wrapped around AES or other symmetric encryption algorithm and exchanges all data using 100% randomized data, with one exception being a user identifier (UID) required for receiving device to lookup user's keys.

2. A method according to claim 1, further wherein the handshake consists of two separate part-one and part-two authentication keys, randomly generated challenge code(s), check sum test data packet(s), and the UID.

3. A method according to claim 2, wherein depending upon vertical application requirements, the authentication keys maybe a complex set of numbers, specialized complex serial numbers or generated from complex data known to both parties and factored into complex keys using SHA-256 or similar one-hashing algorithm. Furthermore, a user's manually entered password may be expanded into part-one and two authentication keys via SHA-256 or similar hashing algorithm using unique data extracted from the sender's device, such as, but not limited to; serial numbers, computer information or data retrieved from security hardware. Furthermore, for Fintech, the Fintech or credit card data is used as or to generate the authorization keys from.

4. A method according to claims 1 through 3, wherein depending upon vertical application requirements, a user identification (UID) value consists of, but not limited to; a serial number, user name, database lookup index, combination of email address and phone number, computer name, device name, a unique identifier or some other combination of unique data to the device or customer. Furthermore, the UID can either be one-way hashed, or encrypted using a reversable UID crypto key, which therein can be unique to the device or software application. Furthermore, for Fintech, the UID is to contain the bank ID and preferably a customer database lookup index from which to lookup the customer's authorization keys.

5. A method according to claims 1 through 4, wherein the check sum test data packet is key to the success of processing and exchanging a user login, command instruction transmittals, database query transmittals, or other sensitive plain text data transmittals. Furthermore, the process consists of the test data packet being created and encrypted by either the sender or receiver using the part-one authentication key or command, database query key or hexadecimal key with “no padding”, then decrypted by the receiving device. If the receiving device correctly decrypts the check sum with its copy of any of the keys, this indicates that both the sender has the correct keys and which command, database query function, or hexadecimal value, if any, is indicated.

6. A method according to claims 1 through 5, wherein depending upon vertical application requirements, wherein the optional challenge code is randomly generated by; (1) the sender, (2) the receiver (3), in which therein consists of up to 256-bits of randomized data, or where a session key is not required, the optional challenge is not generated (4).

7. A method according to claims 1, through 6, wherein depending upon vertical application requirements, the handshake creates and/or exchanges a session key using the challenge key, wherein four options can be utilized; (1) the 256-bit challenge key is copied directly into the session keys, (2) the randomly generated session keys are encrypted by the challenge key, (3) the challenge key encrypts the 256-bit part-two authentication keys to become the session keys, (4) which is the preferred method, wherein the 256-bit challenge key contains address lookup values which are in turn are used to extract a 256-bit subset of keys from the 2,048-bit part-two authentication keys thereby creating 256-bit session keys. Furthermore, options (3) and (4) result with session keys that are never directly transmitted.

8. A method according to claims 1, through 7, wherein depending upon vertical application requirements, command keys, database query keys or hexadecimal keys are created, as per claim 7 option (4) wherein the challenge code stores lookup values for the keys, wherein each separate command, query or hexadecimal key is generated using an incremental variation of challenge code values, thereby allowing 256 possible key variations.

9. A method according to claims 1 through 8, wherein depending upon vertical application requirements, further comprising of handshake method step 1, where the sender creates a hello message, which may include a UID, and may include the challenge code as per claim 6, which therein is transmitted to the receiving device or server.

10. A method according to claims 1 through 9, wherein depending upon vertical application requirements, further comprising of handshake method step 2, wherein the receiving device processes the UID and looks up the user data, if not already, creates the challenge code as per claim 6, creates the check sum test data packet(s) as per claim 5, encrypts the data using the part-one authorization keys and transmits back to the sending device.

11. A method according to claims 1 through 10, further comprising of handshake method step 3, wherein the sending device receives and decrypts the check sum test data packet(s) and if sent, the challenge code using it copy of the part-one authentication keys. Furthermore, the sender then generates the session keys as per claim 7, wherein depending upon vertical application requirements, re-encrypts the check sum test data packet(s) using the session keys, command key(s), or plain text key(s) and transmits back to the receiving device.

12. A method according to claims 1 through 11, further comprising of the handshake method step 4, the receiving having previously created the session keys as per claim 7, therein decrypts the check sum test data packet(s) using its copy of the session keys, command keys, database query keys or hexadecimal keys decrypts the received check sum test data packet(s).

13. A method according to claims 1 through 12, depending upon vertical application requirements, further comprising of handshake method step 5, wherein the decrypted check sum test data packet(s), as per claim 12, are compared to the previously stored sent check sum test data packet(s), if matching, indicates the sender has the correct part-two authentication keys, command keys, database query keys or hexadecimal keys and which command(s), database query(s) or hexadecimal values (0 through 9 and A through F) are indicated.

14. A method according to claims 1 through 13, wherein RFID smart cards and RFID reader terminals are made secure from various low-tech attacks wherein the RFID reader terminal creates the challenge code and test data, the RFID smart card creates a session keys, as per claim 7 option (4), using the challenge code which is then used to modify the check sum test data packet which therein is returned to the terminal for transmittal via a second handshake, as per claims 9 through 13, between the RFID terminal and the RFID authorization server.

15. A method according to claims 1 through 13, wherein Point of Sale (POS) terminal PIN collects the purchase information, which is passed to Fintech smart card, which therein processes the full handshake, as per claims 9 through 13, on behalf of the POS terminal, which acts only a purchase price collector and data courier between the Fintech purchasing server and the Fintech smart card.

16. A method according to claims 1 through 13, wherein Point Of Sale (POS) terminal “Tap” purchase option comprised of a modified handshake is made secure from various low-tech attacks wherein the POS terminal establishes a handshake with the purchasing server, a challenge key and test data packet are created by the POS terminal and passed to Fintech smart card for processing, wherein the Fintech smart card extracts a temporary session key, as per claim 7 option (4), using a special “Tap” authorization part-two key. Furthermore, the encrypted check sum test data packet is passed back to the POS terminal, which in turn, established a new handshake with the Fintech purchasing server, which then transmits the original challenge code, and unmodified test data packet along with the received modified test data packet to the Fintech purchasing server for processing. The purchase value can be encrypted by either the POS terminal or the Fintech smart card.

17. A method according to claims 1 through 16, depending upon vertical application requirements, further comprising of handshake method step 6, an optional approval code is encrypted using the session keys, as per claim 7, and transmitted back to the sending device. If the sending device correctly decrypts the approval code, this completes mutual authentication and the sender knows that the receiving device correctly processed and approved to the handshake transmittal.
